(19) United States
(12) Patent Application Publication
(10) Pub. No.: US 2009/0182834 A1
(43) Pub. Date: Jul. 16, 2009

(54) Device and Method for Providing Data

(76) Inventors: Thomas Zettler, Hoehenkirchen (DE); Friedrich Geissler, Wolfratshausen (DE)

Correspondence Address: SLATER & MATSIL LLP, 17950 PRESTON ROAD, SUITE 1000, DALLAS, TX, 75252, US

(21) Appl. No.: 12/014,555

(22) Filed: Jan. 15, 2008

(51) Int. Cl. G06F 15/16; G06F 1/26

(52) U.S. Cl. 709/208; 709/238; 713/300

(57) ABSTRACT

Devices and methods for providing data via a network are disclosed.

### TECHNICAL FIELD

Embodiments of the present invention relate to devices or methods for providing data.

### BACKGROUND

Besides the distribution of data on data carriers such as compact disks (CDs) or digital versatile disks (DVDs), the providing of data for download via networks like the internet becomes increasingly important. Examples of data which may be provided for downloading via the internet or another network comprises software, video data like movies or audio data, but is not limited to this kind of data.

One possibility for providing data in a network is to provide one or more download servers at a corresponding service provider, for example, a video company, a music company or a software company. Depending on the number of customers using such a server, considerable bandwidth has to be provided to enable download of the data for all possible customers in an acceptable time.

Another approach for providing data in a network is via a so-called peer-to-peer network. In such peer-to-peer networks, each participant may both download data from other participants (“peers”) and at the same time provide data for downloading by other participants. Since in such a peer-to-peer network each participant provides data, the required bandwidth for each participant may be reduced compared with a purely server-based solution as described above. However, the availability of download bandwidth in such a peer-to-peer network depends on the number of peers active at a given time, such that it is hard to give any guarantees in this respect and to ensure an acceptable quality of service. Moreover, conventional peer-to-peer systems are usually implemented as software running on a computer of a participant of the peer-to-peer network, the computer being also used for other purposes, which gives rise to security concerns.

Therefore, a need exists for devices and methods for efficiently providing data in a network.

### SUMMARY OF THE INVENTION

In an embodiment of the invention, a device for providing data via a network is provided. A mass storage stores data and a processor manages peer-to-peer connections via a network. A power control unit is configured to control switched-on time of the device independent of actions taken by a user of the device.

In other embodiments of the invention, other devices and methods are provided.

### BRIEF DESCRIPTION OF THE DRAWINGS

Illustrative embodiments of the present invention will be described with reference to the accompanying drawings which are given for illustrative purposes only and which are not to be construed as limiting, and wherein:

FIG. 1 is a diagram of an embodiment of a system according to the present invention;

FIG. 2 is a block diagram of an embodiment of a device according to the present invention;

FIG. 3 is a circuit diagram of a portion of a processor according to an embodiment of the invention;

FIG. 4 is a circuit diagram of a portion of a processor according to an embodiment of the present invention; and

FIG. 5 is a circuit diagram of a portion of a processor according to an embodiment of the present invention.

### DETAILED DESCRIPTION OF ILLUSTRATIVE EMBODIMENTS

In the following, embodiments of the invention will be described in detail with reference to the accompanying drawings. It is to be understood that the embodiments and the corresponding drawings serve only illustrative purposes to provide a deeper understanding of the present invention, but are not to be construed as limiting the scope of the present invention.

It is to be understood that in the description of embodiments which follow, any connection or coupling between various elements may be realized as a direct connection or coupling without intervening elements, but may also be realized as an indirect connection or coupling with intervening elements unless specifically noted to the contrary. It is further to be understood that elements, units, circuit portions, devices and the like described in the following may be implemented as separate circuits, for example, separate integrated circuits, but also may be implemented in one or more common electronic circuits.

Before the actual description of embodiments, some terms used in the following description will be explained.

A peer-to-peer network relates to a network wherein each entity or participant connected to the network (also referred to as “peer”) may both retrieve, e.g., download, data from the network and provide, e.g., upload, data to the network to be retrieved by other peers. Such peer-to-peer networks may be implemented in embodiments using conventional technology and protocols, both configurations including a central server as in the Napster system and systems without such a central server like peer-to-peer networks based on, e.g., the BitTorrent, Gnutella, eMule, Azureus or VarVar system or protocol.

“Mass storage” or “mass storage device” refers to a large capacity storage able to store data in digital format. A mass storage can, for example, comprise one or a combination of a plurality of the following items: a hard disc drive, a hard disc drive array, a CD drive, a DVD drive, a flash memory, and a RAM-type memory, but is not limited thereto.

Data provided via a network relates to any type of data which is provided to be retrieved or downloaded by entities connected to the network. Such data may, for example, comprise application software, videos, audio files, but is not limited to these.

“Service provider” or “content provider” refers to an entity which is responsible for providing data via a network. For example, such a content provider may provide videos or audio data via the network to clients, wherein the clients may have to pay for downloaded data in some manner. It should be noted that the fact that the service provider or content provider is responsible for providing the data in the context of this application does not necessarily imply that the service provider or content provider actually has to provide the data via his own server, but may also use other entities for providing the data, for example a peer-to-peer network.

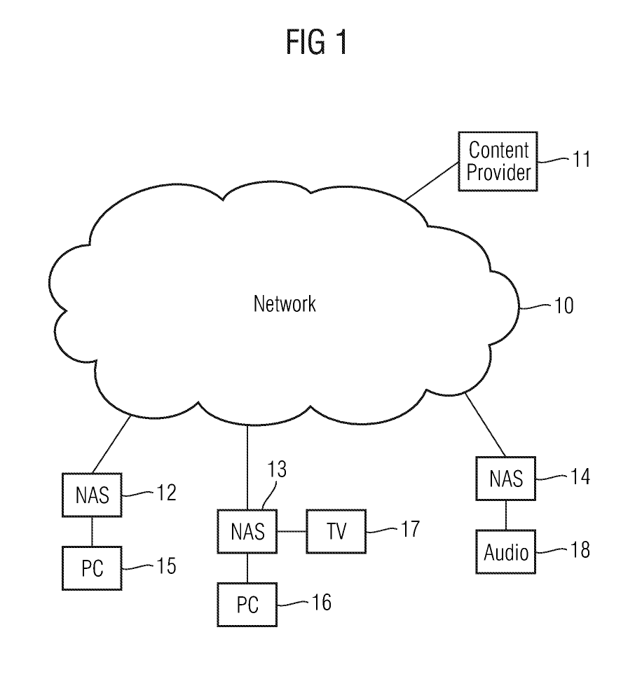

Turning now to FIG. 1, a system for providing data according to an embodiment of the present invention is shown. The system of FIG. 1 comprises various entities communicating via a network 10. Network 10 in an embodiment is the Internet. In another embodiment, network 10 may be another kind of network, for example, a local network or an intranet. Communication via network 10 may comprise wire based communication, wireless communication or combinations thereof. For example, network 10 may comprise a backbone network, wherein various entities may be connected with the backbone network with wire-based techniques like DSL (digital subscriber line) or wireless techniques like WLAN.

In the system of FIG. 1, network access storage devices 12, 13 and 14 according to embodiments of the present invention are connected to network 10. While in FIG. 1 three network access storage devices 12, 13 and 14 are depicted, any number of such devices may be provided, and other types of devices may additionally be connected to network 10.

In an embodiment, network access storage devices 12, 13, 14 are located, for example, in the homes or offices of clients of a content provider 11, which is also connected to network 10 in the embodiment of FIG. 1. In an embodiment of the invention, network access storage devices 12, 13, 14 each have a first interface for interfacing with network 10 and at least one second interface for interfacing with further equipment. For example, network access storage device 12 interfaces with a personal computer 15, network access storage device 13 interfaces with a personal computer 16 and a television set 17, and network access storage device 14 interfaces with audio equipment 18. These additional devices serve merely as examples, and network access storage devices according to embodiments of the present invention may be configured to interface with any suitable electronic device, e.g., a device which may use data downloaded via network 10.

In an embodiment, network access storage devices 12, 13 and 14 as well as further network access storage devices that are not shown and that may be connected to network 10 form a peer-to-peer network for exchanging data via network 10. For example, network access storage device 13 may download a video which may be stored on network access storage device 12 and/or network access storage device 14 to be displayed on television set 17.

In the embodiment of FIG. 1, network access storage devices 12, 13 and 14 are unitary devices which are at least to some extent controlled by a content provider 11 connected to network 10. For example, content provider 11 may originally supply data to the peer-to-peer network comprising network access storage devices 12, 13 and 14. To this end, in an embodiment content provider 11 may send data to be stored in a mass storage incorporated in one of the network access storage devices 12, 13 and 14 independently of actions taken by a user of the respective network access storage device.

In an embodiment, content provider 11 may at least partially control the time periods in which network access storage devices 12, 13, 14 are switched on and/or switched off in order to ensure that sufficient network access storage devices are always available in the peer-to-peer network for providing data. In an embodiment, this may be effected by setting corresponding parameters in the network access storage devices which influence the time during which they are switched on or switched off. In another embodiment, additionally or alternatively, content provider 11 may supervise network access storage devices 12, 13 and 14 to ensure payment for data downloaded via the peer-to-peer network.

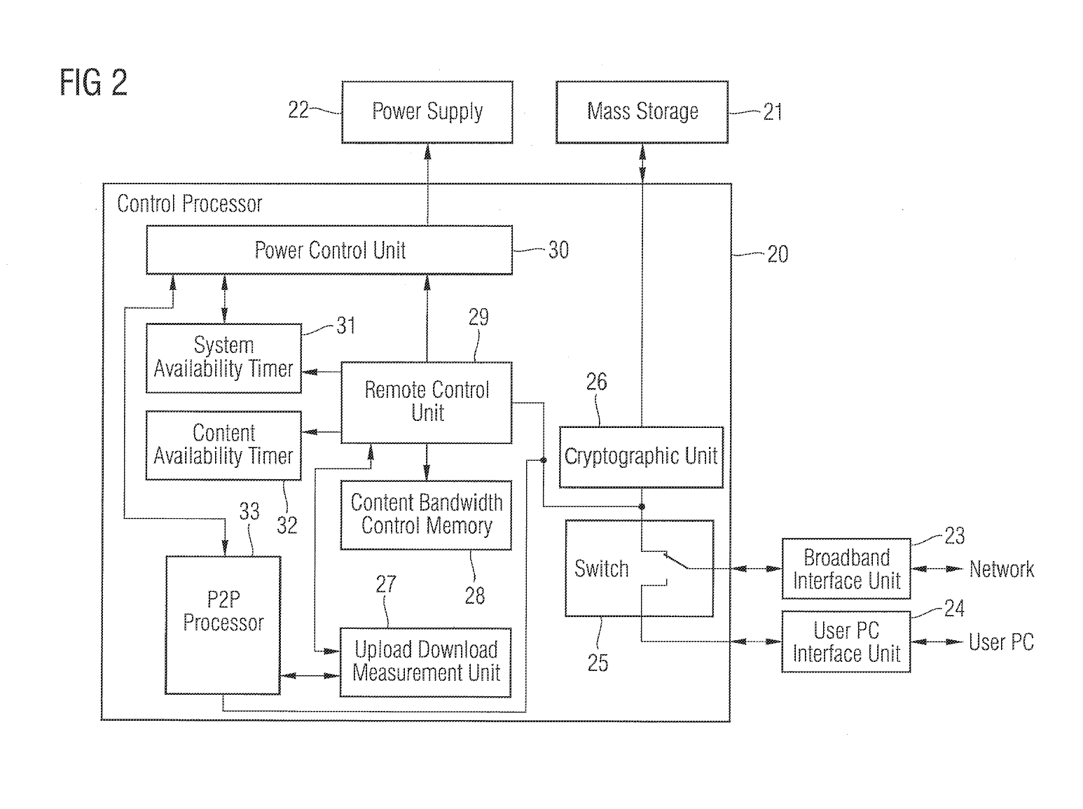

Turning now to FIG. 2, an embodiment of a device for providing data according to the present invention is shown, which device may, for example, be used as a network access storage device 12, 13 and/or 14 in the embodiment of FIG. 1.

The device of the embodiment of FIG. 2 comprises a control processor 20 controlling the device, a mass storage 21, a power supply 22, a broadband interface unit 23 and a user PC interface unit 24. Mass storage 21 provides storage capacity for storing data downloaded from other devices in a peer-to-peer network and/or from a server of a content provider. Mass storage 21 may, for example, comprise one or more hard discs and/or solid state memory, for example, non-volatile memory. Power supply 22 provides power to the device. Broadband interface unit 23 provides an interface to a network like network 10 of FIG. 1, for example, to be able to participate in a peer-to-peer network formed using the network. To this end, broadband interface unit 23, for example, may comprise a DSL modem or an interface to a DSL modem, an ethernet connector, a wireless access circuit and the like. User PC interface unit 24 provides an interface to a user PC like PCs 15 and 16 of the embodiment of FIG. 1 and may, for example, comprise an interface like a USB (universal serial bus) interface, a firewire (IEEE 1394) interface or an Ethernet interface.

Although not explicitly shown, the device of FIG. 2 may comprise further interfaces for interfacing with further equipment like a television or audio equipment, or user PC interface unit 24 may be configured as a multi-purpose interface, for example, a USB interface, capable of interfacing with various types of devices.

The device of FIG. 2 is controlled by control processor 20, which will be described in detail next. Control processor 20 in the embodiment of FIG. 2 comprises various components 25-33. While these components are depicted as being part of control processor 20 in the embodiment of FIG. 2, in another embodiment some or all of these components may also be implemented external to control processor 20. Furthermore, in another embodiment only some of the components may be present.

It is to be noted that while some connections between the various elements of control processor 20 are depicted in FIG. 2, additional connections which are not shown may be provided, and/or some or all of the components may communicate with each other via a common bus system.

In the embodiment of FIG. 2, control processor 20 comprises a switch 25 which is coupled with broadband interface unit 23 and user PC interface unit 24. In an embodiment, switch 25 is configured such that data related to the operation of a peer-to-peer network comprising the device of FIG. 2, e.g., data exchanged via the peer-to-peer network, is processed within the device, whereas other data is forwarded to user PC interface unit 24 and a user PC connected thereto. For example, in an embodiment, data handled under authority of a content provider is marked, for example, in a header of corresponding data packets, and switch 25 forwards only data which is marked in this way to process within the device of FIG. 2. In such an embodiment, through switch 25 the communication within the peer-to-peer network may be separated from other data communication performed by a user of the device. In such an embodiment, the operation of the peer-to-peer network is independent of a user PC connected to user PC interface unit 24.

In another embodiment, switch 25 may be configured such that the device may be also used for downloading data besides the peer-to-peer network.

The device of the embodiment of FIG. 2 further comprises a peer-to-peer processor 33 configured to establish connections and performing uploads and/or downloads, i.e., data transmission to and from other entities forming part of the peer-to-peer network, or, in other words, to manage the connection of the device to the peer-to-peer network. In an embodiment, peer-to-peer processor 33 is a standard multi-purpose processor running an appropriate software, for example a peer-to-peer software like BitTorrent or μTorrent. In another embodiment, peer-to-peer processor 33 may comprise specific hardware for accelerating operations necessary for managing the connection to the peer-to-peer network.

As already mentioned, data downloaded from the peer-to-peer network from a content provider are in the embodiment of FIG. 2 stored in mass storage 21, and when a download request is received from another entity of the peer-to-peer network, the corresponding data is read from mass storage 21 and provided to the peer-to-peer network via broadband interface unit 23.

Control processor 20 of the embodiment of FIG. 2 furthermore comprises a cryptographic unit 26 arranged between switch 25 and mass storage 21 for encrypting and/or decrypting data to be stored in mass storage 21 and for encrypting and/or decrypting and/or decrypting data read out from mass storage 21. In an embodiment, cryptographic unit 26 uses a key-based algorithm like DES, RSA or AES to prevent unlicensed copying of data stored in mass storage 21. In particular, in an embodiment with a cryptographic algorithm downloads from mass storage 21 by other entities in the peer-to-peer network may be authorized by a content provider to ensure that only authorized entities, for example, entities who have paid for the respective data, may download the data.

In an embodiment using a key-based encryption algorithm, to this end the content provider sends a download request encrypted with a public key of the device of FIG. 2. The device responds with a random sequence encrypted with a public key of the content provider. For confirmation of the validness of the request, i.e., to prevent third parties from taking such a download request, the content provider responds with the same sequence encrypted with the public key of the device of FIG. 2. Only after this sequence has been received, is the download enabled. In another embodiment, the device may store public keys of other entities of the peer-to-peer network and encrypt data to be sent to such another entity with the corresponding public key.

In another embodiment, data or content may be encrypted with a data specific key by the content provider before distributing the data to the network, and only entities of the network having received the corresponding key for decryption from the content provider are able to decrypt the encrypted data and therefore use it.

In the embodiment of FIG. 2, control processor 20 further comprises a remote control unit 29 enabling a remote control of the device by a content provider via a network and broadband interface unit 23. In an embodiment, a remote control protocol like TR69 is used. Via remote control unit 29, a content provider may influence various components of control processor 20 as will be explained in the following in more detail.

Control processor 20 further comprises a power control unit 30 controlling power supply 22 for switching on and off the device of the embodiment of FIG. 2. In the embodiment of FIG. 2, power control unit 30 may be directly controlled by a content provider via remote control unit 29, i.e., a content provider may switch the device on and off as needed. Another possibility for controlling power control unit 30 is via a system availability timer 31. In system availability timer 31, an availability time of the system, for example, a number of hours per day, and/or specific time periods (for example, “from 2 pm to 5 pm”) during which the device is to be available are stored. In the embodiment of FIG. 2, the values stored in system availability timer 31 may be set by a content provider via remote control unit 29. In the embodiment of FIG. 2, furthermore system availability timer 31 controls power control unit 30 such that the system is automatically switched on after the availability time stored in system availability timer 31 has expired and/or to switch the device on during the time periods stored in system availability timer 31.

In an embodiment, power control unit 30 is configured to be able to switch on and off parts of the device, e.g., mass storage 21, power supply 22, control processor 20 or parts thereof and interface units 23, 24, individually such that different power saving states may be obtained. A full or partial switch-off of the device may therefore be effected, e.g., depending on the mechanisms already described above like remote control by a content provider.

In an embodiment, a power switch is provided in the device of FIG. 2 (not shown) such that a user may turn on the device when needed. Further, in an embodiment the user may be unable to manually switch off the device, but the device may be switched off only by system availability timer 31 and/or remote control unit 29 via power control unit 30, or may be unable to manually switch off the device unless the availability time stored in system availability timer 31 has expired.

Remote control unit 29 may, in an embodiment, further be used by a content provider to control peer-to-peer processor 33 to download specific contents or data from other entities connected to the peer-to-peer network and/or from the content provider. In such an embodiment, the content provider can control which contents are available on which device and may, for example, increase the number of peers or devices connected to the peer-to-peer network storing data which is in high demand, for example, a particular popular video.

In the embodiment of FIG. 2, control processor 20 further comprises an upload/download measurement unit 27. This unit measures the amount of data downloaded by the device of FIG. 2, i.e., retrieved from the peer-to-peer network, and the amount of data uploaded to the peer-to-peer network, i.e., data downloaded from the device of FIG. 2 by other entities connected to the peer-to-peer network. Upload/download measurement unit 27 in the embodiment of FIG. 2 may be read out by the content provider via remote control unit 29, and the system availability timer 31 may be set and/or power control unit 30 may be controlled depending on the values ascertained by upload/download measurement unit 27. In an embodiment, for example, the time the device of FIG. 2 is switched on may be increased if the ratio of uploaded data amount and downloaded data amount drops below a predetermined value, or may be increased if it exceeds a predetermined value. In this way, in an embodiment, devices which download more data from the network are made available for longer periods of time thus enabling a greater amount of upload.

In an embodiment, upload/download measurement unit 27 also measures content specific upload and download information which may be used by the content provider to tailor the available data to the demands. In another embodiment, a distinction may be made between downloads initiated by the content provider in order to increase the availability of certain data and downloads initiated by a user of the device.

The device of the embodiment of FIG. 2 further comprises a content availability timer 32 which also may be controlled by a content provider via remote control unit 29. In content availability timer 32, a time determining how long certain data stored in mass storage 21 is available for download is stored. In an embodiment, a single time is used for all data in mass storage 21. In another embodiment, the time may be set content specific, i.e., for each content or data stored in mass storage 21 separately.

In an embodiment, when the time set in this manner has expired, the data is deleted from mass storage 21. In another embodiment, the data remains in mass storage 21 even after the expiry of the set time. Such data may then be deleted if the storage space in mass storage 21 is needed for further data, and/or upon specific request from the content provider. In an embodiment, after the expiry of the set time, content provider 11 may send a command to make the data available again such that the time for expiry, either the same time or a different time, runs anew.

Via remote control unit 29, a content provider also may configure the device shown in FIG. 2, for example, when first connecting the device to the network, and may also perform updates like software or firmware updates.

In the embodiment of FIG. 2, control processor 20 further comprises a content bandwidth control memory 28 controlled by remote control unit 29 for controlling the bandwidth made available for data stored in mass storage 21. For example, data stored in mass storage 21 which is rarely requested for download in the peer-to-peer network may be assigned a bandwidth of zero, which is also referred to as a choked state. On the other hand, a higher bandwidth or higher priority may be assigned to data in mass storage 21 the download of which is requested frequently. In such a manner, data in high demand may use a greater portion of the total bandwidth available in the device and/or may have a higher priority compared with other data stored in mass storage 21.

As already mentioned previously, while control processor 20 of the embodiment of FIG. 2 comprises a plurality of different units for providing a plurality of different functions, in other embodiments only some of these units or function may be provided. For example, in an embodiment, no content bandwidth control memory and/or no content availability timer may be provided. Further, while in the embodiment of FIG. 2 power control unit 30 basically may be controlled in three different ways, namely directly by remote control unit 29, via system availability timer 31 and/or based on measurements obtained by upload/download measurement unit 27. In another embodiment, only one or two of the possibilities may be provided. Furthermore, it should be noted that some of the functions may be implemented jointly, for example, system availability timer 31 and content availability timer 32 may share a single timer, or content bandwidth control memory 28 may be implemented using a memory of peer-to-peer processor 33. Furthermore, one or more of the units shown like cryptographic unit 26 or system availability timer 31 may be implemented as software running on peer-to-peer processor 33 and being stored in a memory (not shown).

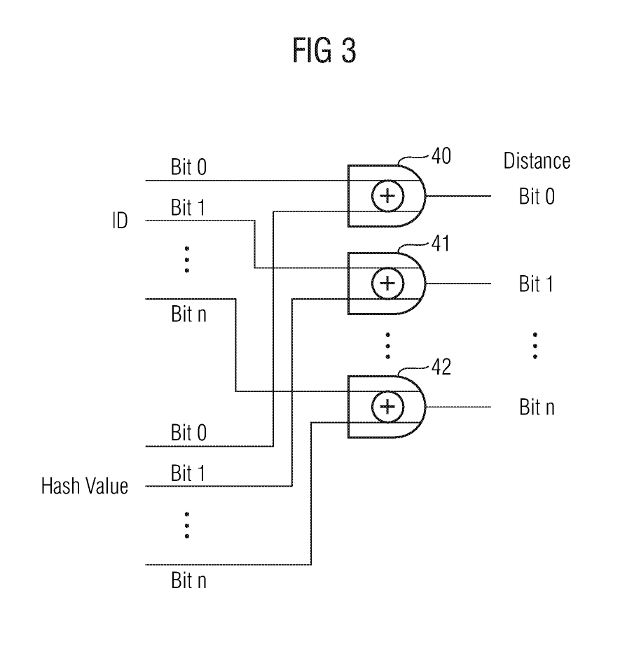

As already mentioned above, in an embodiment peer-to-peer processor 33 is a standard processor running appropriate software. In another embodiment, peer-to-peer processor 33 comprises dedicated hardware for establishing and/or managing the data transfer via the peer-to-peer network. Embodiments of such a peer-to-peer processor, which also may be used in other peer-to-peer devices than those discussed above, will be explained next with reference to FIGS. 3-5.

In the embodiments of FIGS. 3-5, a peer-to-peer processor uses a peer-to-peer method of the so-called third generation like BitTorrent, Azureus, eMule, VarVar although in another embodiment other peer-to-peer implementations or methods may also be used. In an embodiment, the peer-to-peer method uses a distributed hash table for locating data in the peer-to-peer network, for example, using the so-called Kademlia algorithm. In such an algorithm, to each data or information stored in the network, for example, in mass storage 21 in case the peer comprises the embodiment shown in FIG. 2, a hash value is assigned. In other words, the hash value characterizes or identifies, for example, the name of data, information or content a peer has stored.

Furthermore, each peer has an identification (ID) in the network, which in case of the internet or a similar network may correspond to its IP address, but may also be a value specifically assigned the peer-to-peer network independent of the IP address in the network. In an embodiment, a number of bits of the ID corresponds to a number of bits of the hash value.

In the Kademlia algorithm or similar algorithms which may be employed in embodiments of the present invention, a peer having data stored therein searches another peer in the peer-to-peer network the ID of which has the shortest distance to the hash value of the data and transfers contact information to this peer. A peer searching for the data performs the same distance calculation and therefore finds the peer which has contact information describing where the data is stored. This distance is not to be confused with a physical distance. In an embodiment using the Kademlia algorithm, a XOR (exclusive-or) function is used for distance calculation.

In an embodiment of a peer-to-peer processor, the processor comprises hardware for calculating this distance. Such hardware according to an embodiment is schematically shown in FIG. 3.

The hardware of FIG. 3 which is incorporated in a peer-to-peer processor according to an embodiment comprises a plurality of XOR-gates 40, 41 . . . , 42 corresponding to a number of bits of the above-mentioned hash value which as explained above corresponds to a number of bits of the ID of the peers. As shown in FIG. 3, to calculate a distance bit 0 of the ID and bit 0 of the hash value are fed to XOR gate 40, bit 1 of the ID and bit 1 of the hash value are fed to XOR gate 41 etc., and bit n, i.e., the last bit of the ID, and bit n of the hash value are fed to XOR gate 42. The resulting distance corresponds to the output of XOR gates 40-42, wherein XOR gate 40 outputs bits 0 of the distance, XOR gate 41 outputs bit 1 of the distance and XOR gate 42 outputs bit n of the distance. In other words, in this embodiment the number of XOR gates corresponds to the number of bits of the ID which in turn corresponds to the number of bits of the hash value.

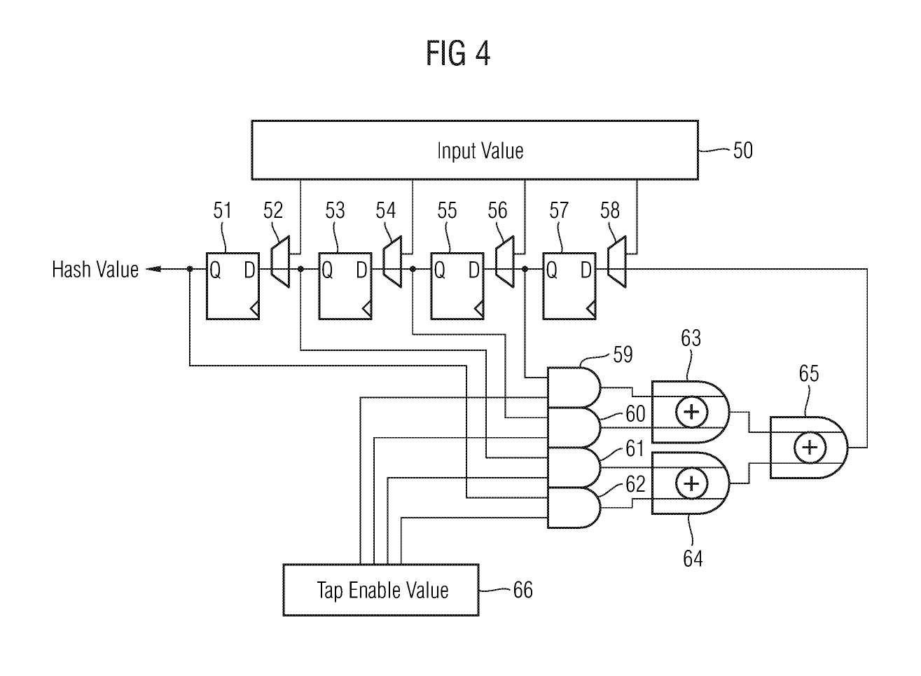

In another embodiment of a peer-to-peer processor according to the present invention, additionally or alternatively, hardware may be provided for calculating the hash value for given data. A possible implementation of such a hardware according to an embodiment is shown in FIG. 4. In the embodiment of FIG. 4, 4-bit hash values are calculated as an example. However, in another embodiment hash values having a different number of bits may be calculated.

In the embodiment of FIG. 4, for calculating the hash value a fed-back shift register is used comprising four D-flipflops 51, 53, 55 and 57 as shown in FIG. 4. The calculated hash value is read out serially from output Q of D-flipflop 51.

An input value, for example, corresponding to a file name or title of the data for which the hash value is to be calculated is stored in a register 50. Bits of this input value are supplied to D-flipflops 51, 53, 55 and 57 via multiplexers 52, 54, 56 and 58, respectively.

The outputs of D-flipflops 51, 53, 55 and 57 are fed back to an input D of D-flipflop 57 via a feedback structure comprising AND gates 59, 60, 61 and 62 the output of which are supplied to XOR gates 63, 64, the outputs of which in turn are supplied to an XOR gate 65.

As shown in FIG. 4, each output of D-flipflops 51, 53, 55 and 57 is supplied to a first input of one of AND gates 59, 60, 61, 62. Furthermore, in a register 66 which in the embodiment of FIG. 4 is a 4-bit register, a 4-bit tap enable value is stored, wherein each bit of the tap enable value is fed to a second input of one of AND gates 59, 60, 61 and 62 such that by setting the corresponding bits of the tap enable value it is possible to determine which of the outputs of D-flipflops 51, 53, 55 and 57 are actually used for feedback. For example, in an embodiment if the tap enable value is “1111”, all the outputs are used for feedback, i.e., the outputs of AND gates 59, 60, 61 and 62 correspond to the corresponding output value of D-flipflop 51, 53, 55 and 57 fed to the respective AND gate, whereas in case of a tap value of 0000, the outputs of the AND gates would always be 0.

It should be noted that the embodiment of FIG. 4 is to be seen merely as an illustrative example how one example of a calculation method for the hash value may be implemented in a hardware, and in other embodiments, the hash value may be calculated in a different manner, which then could be implemented in a different hardware in another embodiment of the invention.

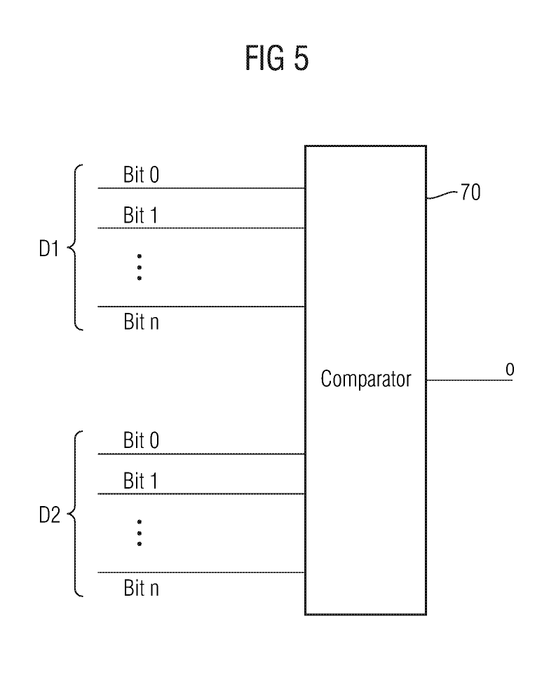

With hash values as, for example, calculated with the embodiment of FIG. 4, distances to a peer having an ID may be calculated, for example, with the embodiment of FIG. 3. In an embodiment, when a peer intends to download certain data, it calculates a distance between the hash value corresponding to the desired data and a plurality of peers using their respective IDs, and then the peer corresponding to the shortest distance is contacted. In an embodiment, a peer-to-peer processor comprises hardware accelerating the calculation of the shortest distance. A possible implementation of such hardware according to an embodiment is shown in FIG. 5. The embodiment of FIG. 5 comprises a comparator 70 to which two distances D1, D2 each being n-bit values are fed. An output signal o indicates which distance is smaller. In an embodiment, o=1 if D1≦D2, and o=0 if D1>D2. As a matter of course, in another embodiment o may assume different values to indicate the relationship between D1 and D2 than the ones indicated above. Furthermore, in another embodiment, comparator 70 may comprise inputs for more than two distances in order to perform a comparison between more than two distances in hardware.

It is to be noted that the embodiments of FIGS. 3, 4 and 5 may all be implemented in an embodiment of a peer-to-peer processor according to the present invention, but in another embodiment only one or two of these embodiments and/or other acceleration hardware may be implemented, wherein the remaining functions in an embodiment may, for example, be implemented in software.

While various embodiments of the present invention have been described above, the present invention is not limited to these embodiments, and plurality of possibilities for modifications or variations has been given above. Therefore, the scope of the present invention is not intended to be limited by the embodiments described herein and shown in the drawings, but is intended to be defined only by the appended claims and equivalents thereof.

What is claimed is:

1. A device for providing data via a network, the device comprising:
a processor to manage peer-to-peer connections via the network;
a mass storage coupled to the processor, the mass storage to store data; and
a power control coupled to the processor, the power control configured to control a switched-on time of the device independent of actions taken by a user of the device.

2. The device of claim 1, wherein the power control is configured to control the switched-on time of the device depending on information received from a content provider via the network.

3. The device of claim 1, wherein the power control is configured to switch off the device after it has been switched on a predetermined time.

4. The device of claim 3, further comprising a timer to measure a time the device has been switched on.

5. The device of claim 1, wherein the power control is configured to control the switched-on time of the device depending on a ratio between an amount of data downloaded by the device from the network and an amount of data uploaded by the device to the network.

6. The device of claim 1, wherein the processor and the power control are integrated in a single integrated circuit.

7. A device for exchanging data via a network, the device comprising:
a first interface to connect with a network;
a second interface to connect with user equipment; and
a switch circuit to selectively forward data received via the first interface to the second interface or for further processing within the device.

8. The device of claim 7, wherein the first interface comprises a DSL interface.

9. The device of claim 7, wherein the second interface comprises a universal serial bus interface or an IEEE 1394 interface.

10. The device of claim 7, further comprising a mass storage unit coupled to the switch circuit.

11. The device of claim 10, wherein the switch circuit is configured to forward data to the mass storage unit if the data comprises a predetermined identifier.

12. The device of claim 11, wherein the predetermined identifier identifies the data as authorized by a predetermined content provider.

13. A device for providing data via a network, the device comprising:
a storage device to store data received from a network;
a processor circuit to manage peer-to-peer connections via the network; and
a remote control circuit to enable a remote control of the device via the network.

14. The device of claim 13, wherein the remote control circuit is configured to enable the storing of data on the storage device initiated via the network.

15. The device of claim 14, wherein the remote control circuit enables the storing of data initiated by a content provider.

16. The device of claim 13, further comprising:
a power control circuit configured to control at least one of a switching on and a switching off of the device depending on predetermined criteria,
wherein the remote control circuit is configured to enable the setting of the predetermined criteria via the network.

17. A processor for managing peer-to-peer connections via a network, the processor comprising:
at least one hardware-implemented function to support managing of peer-to-peer connections.

18. The processor of claim 17, wherein the at least one hardware-implemented function comprises a function selected from the group consisting of a distance calculation, a hash value calculation and a distance comparison.

19. The processor of claim 18, wherein the processor comprises at least one exclusive-OR gate configured to calculate a distance between a hash value identifying data and an identification identifying a participant of a peer-to-peer network.

20. The processor of claim 18, wherein the processor comprises a feedback shift register circuit to calculate a hash value identifying data to be exchanged via the network.

21. The processor of claim 20, wherein a feedback loop of the feedback shift register circuit comprises at least one AND gate and at least one exclusive OR gate downstream of the at least one AND gate.

22. The processor of claim 18, wherein the processor comprises a comparator to compare a first distance and a second distance.

23. A method for operating a peer-to-peer network, the method comprising:
controlling at least one peer of the peer-to-peer network by a central server to determine a time during which the at least one peer is switched on.

24. The method of claim 23, wherein the controlling step comprises setting an upload/download ratio for the at least one peer.

25. The method of claim 23, wherein the controlling step comprises setting a switched-on duration for the at least one peer.

26. The method of claim 23, further comprising:
initiating a storage of data on a storage device of at least one peer connected to the peer-to-peer network by a central server.
